(19) United States
(12) Patent Application Publication
(10) Pub. No.: US 2012/0254008 A1
(43) Pub. Date: Oct. 4, 2012

(54) METHOD AND SYSTEM FOR TRADING AND CLEARING FINANCIAL INSTRUMENTS VIA A MESSAGING INTERFACE

(76) Inventor: Neal B. Brady, Evanston, IL (US)

(21) Appl. No.: 13/079,505

(22) Filed: Apr. 4, 2011

(51) Int. Cl. G06Q 40/00

(52) U.S. Cl. 705/37

(57) ABSTRACT

A system allowing customers to use instant messaging (IM) (or other non-financial information exchange compliant communication based) communications to communicate market actions directly to an electronic facility platform that, in turn, publishes market data and matches orders according to standard exchange trading protocols and allows for direct communication with at least one market participant via a financial information exchange compliant communication network for negotiating the terms of and entering into bilateral transactions with the at least market participant, without the need for a human intermediary. The system and method allows matching and publishing market data for Over the Counter (OTC) contracts, OTC cleared contracts, and for the routing of orders to Exchange central limit order books.

### 1. TECHNICAL FIELD

The present invention relates generally to a method and a system for receiving and processing financial instrument trading instructions or market actions via a messaging, e.g. Instant Messaging (IM), interface and for providing feedback using the same. In one particular embodiment, the method and system are useful for over-the-counter (OTC) contracts. In other embodiments, the method and system are useful for cleared OTC contracts and for block traded or “off exchange” traded futures and options contracts.

### 2. RELATED ART

Equities, equity options, fixed income, energy, foreign currency derivatives, etc. collectively referred to herein as “financial instruments,” have been traded in this country since the late 1700s. Traditionally, such financial instruments have been traded on floor-based exchanges, such as the New York Stock Exchange (NYSE) or the American Stock Exchange (AMEX). The predominant method of trading in these floor-based environments is known as the “open outcry” system, which involves oral communications between market participants at a central location in open view of other market participants. In this system, an order is typically relayed out to a trader standing in a “pit.” The trader shouts out that he has received an order and waits until a broker shouts back contract terms, and a trading transaction then results. This exchange based process, however, has been almost entirely or at least partially automated by the use of computers and computer devices.

In contrast to and in parallel with above exchange based trading, there exists the over-the-counter (OTC) market where financial instruments are traded directly between two parties. The OTC contract is a bilateral contract, i.e., a contract in which two parties agree on how a particular trade or agreement is to be settled in the future. Examples of financial instruments that are traded in the OTC market include derivatives such as swaps, forward rate agreements, options, weather, inflation, exempt commodities such as energy, metals, chemicals, emission allowances, etc. To manage counter party risk, often the parties will mutually agree to transfer the trade to a clearing house such as the Chicago Mercantile Exchange's (“CME's”) ClearPort or the Intercontinental Exchange's (“ICE”) IceClear to reduce and/or eliminate credit and performance risk of the initial OTC transaction counterparts.

Sophisticated parties in the OTC market such as hedge funds, banks, and market makers communicate in many electronically traded markets via a financial information exchange compliant communication. One example of such a standard is the Financial Information exchange (FIX) protocol that is widely used in the field of financial services. The FIX protocol is a nearly universal standard for exchange of such types of information in the securities field. Examples of alternative protocols include FIXML (FIX adapted to XML) and FPML.

There are, however, a vast number of traders who arrange their trades using the phone, a facsimile, electronic mail (e-mail), and more frequently, Instant Messaging (i.e., IM or IMing). This method of trading is particularly prevalent in the OTC energy and agricultural commodity markets. IM differs from ordinary e-mail in the immediacy of the message exchange and also makes a continued exchange simpler than sending e-mail back and forth. In addition, most IM communications are text-only. To access an IM service, a user registers with a service provider and, after connecting to the Internet (or other appropriate data network), enters their screen name and password to log in to the IM network. Popular IM applications include AOL's Instant Messenger (AIM) and Microsoft's Network Messenger Services (MSN), Yahoo's Yahoo! Messenger and Google's Google Talk. Once a user has logged in to the appropriate IM network, his/her presence on the system is made known to all authorized partners (commonly termed “buddies”). The user can then engage in free-form, textual conversations with other IM users, i.e., with the user's buddies who are connected to the system.

Because IM is almost completely a text-based service, IM communication is generally not burdened by the need to transfer large graphic, sound, or program files. As a result, IM communications are truly “instantaneous” under most conditions. Even during peak Internet usage periods, the delay is rarely more than a couple of seconds. Despite this feature, because IM is text-based, such communications are still ineffective for directly communicating with the trading counter-parties who generally communicate using financial information exchange compliant communication. Therefore, there is a need for a system or method to translate the market actions of an IM user into a protocol that can be read in an automated fashion by a financial information exchange compliant communication. The financial information exchange compliant communication is based on FIX, or some other standard messaging based trading protocol. Via this translation network, the IM user is able to seamlessly interact with the more automated financial information exchange compliant communication-based user. The more sophisticated user is also able to apply more sophisticated tools (pricing engines, mass-quote engines) to interact with market actions that originate from IM-based text messaging users.

### SUMMARY

The present invention provides a system that allows individuals to use instant messaging (IM) (or other non-financial information exchange compliant communication-based text) communications to request quotes, enter orders, execute, and trade financial instruments. The invention is particularly suitable for OTC trading.

In one embodiment, the system or method includes a computerized system that receives a communication from a communications network. The communication is generally a text-based communication that originates from a user that is in communication with an IM service. The communication is scanned to identify at least one of a predefined plurality of keywords, some of which correspond to actions that might be addressed by one or more market participants. If one or more keywords are present in the communication, the communication is parsed and is converted it to a financial information exchange compliant communication, which can then be disseminated via a communication network to other parties such as market participants, who can act on the message and consummate a trade.

Simultaneously, the financial information exchange compliant communication can be transmitted to a facility engine to build an order book or to augment a pre-existing order book. The method of the present invention may also include a matching engine, which can use the information in the order book to match bid and offer prices or to match other pieces of information. Advantageously, those parties who use the financial information exchange compliant communication can communicate with a party who does not use the financial information exchange compliant communication but instead communicates using IM. Accordingly, a trader using an IM communication can request quotes, enter or cancel orders, or execute trades using an IM communication while at the same time, another party can respond to such a trader using a financial information exchange compliant communication.

As used in the specification and claims, the phrase “financial instrument” is to be construed broadly and may include, but is not limited to derivatives such as swaps, forward rate agreements, options, weather, inflation, exempt commodities such as energy, metals, chemicals, emission allowances, etc.

The phrase “financial information exchange compliant communication” refers to one of a FIX protocol, a FIXML protocol, or a FPML protocol compliant communication or any communication that is supported by any one of the FIX protocols described on the fixprotocol.org web site.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a diagram of an exemplary environment for processing of orders for trading of financial instruments that is in accordance with the present invention.

FIG. 2 is a diagram of an exemplary process for a trade of a financial instrument in accordance with the present invention.

### DETAILED DESCRIPTION

The present invention allows a trader (sometimes referred to as a user or customer) to use instant messaging (IM) communications to directly communicate with an electronic facility or platform so that the trader can negotiate the terms of and enter into bilateral transactions with one or more market participants. A trader may then electronically provide trading orders directly from a device using an IM communication to the electronic facility that will convert the IM communication into a compliant financial information exchange communication that can be disseminated to market participants or other institutions, who can then act on the message. The method of the present invention also creates an order book or augments an existing order book. The present invention also provides a system capable of providing order status communications, i.e., confirmation of a trade and/or confirmation of clearing to the trader in an IM communication and to the market participants in a financial information exchange compliant communication.

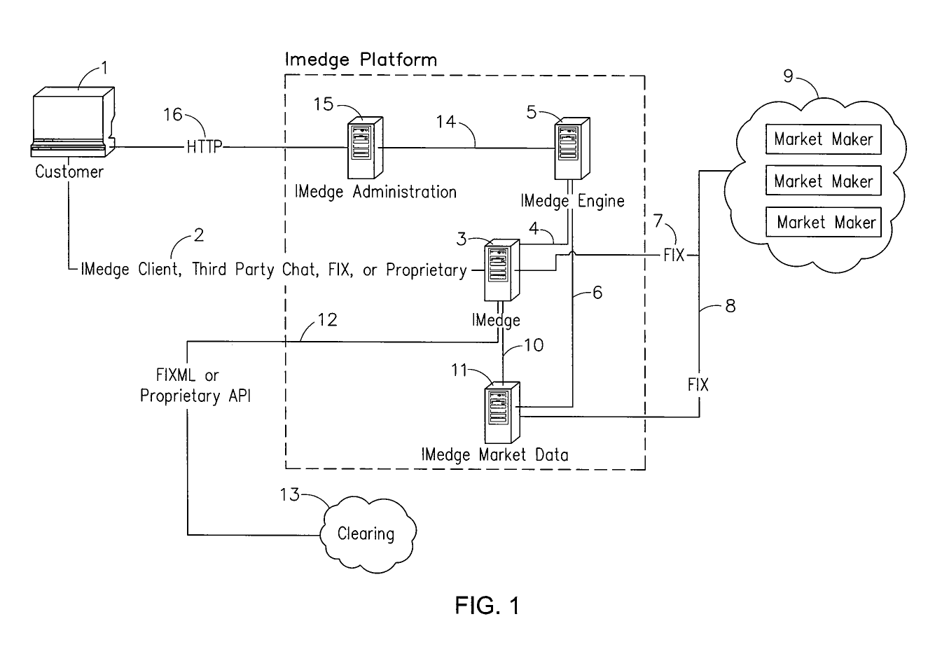

The present invention may be understood with reference to the exemplary, simplified network environment illustrated in FIG. 1. Customers 1 access the electronic facility platform 50 via an electronic facility proprietary client, a third party IM system (such as AOL Instant Messenger (AIM®), YAHOO!®, MSN®, Google®), via direct financial information exchange compliant communication connection, or some other proprietary means 2.

For example, the customer 1 may use his client device 20, such as a personal computer, a PDA, an internet-enabled mobile phone or the like to communicate instant messages via a public or private IM network, to the electronic facility platform 50 and thus indirectly to and/or through the session manager 3. Generally, such communications are transmitted by HTTP via the World Wide Web, i.e., the Internet. The IM communications may be encrypted using SSL encryption, or otherwise secured, due to the sensitive financial nature of such communications.

In one embodiment, the client device 20 is configured with standard, commercially available IM client software, such as the AOL Instant Messenger (AIM®), YAHOO!®, MSN®, Google®, or any other service capable of sending and receiving instant messages. In such an embodiment, generally available, generally accessible public IM networks, and public IM software, may be used in accordance with the present invention. Alternatively, the present invention may be configured to interface with a private and or proprietary IM network. To establish the IM functionality, an account with an IM service provider, the required hardware, software and operating system, and a network connection is needed.

In an alternative embodiment, the client device 20 is configured with specially configured IM client software that can provide a customized user interface so that the customer can input information by typing and/or selecting options from specially configured menus and/or providing data via a customized GUI. The specially configured IM client software may be further configured to provide additional features.

Generally, the IM communications sent from a customer 1 via the client device 20 are textual in nature and are formatted according to the IM network provider's protocol. Such communications are not compatible with the financial information exchange compliant communication protocol used by the market participants 9. Accordingly, in accordance with the present invention, the session manager 3 receives an IM communication and scans it to determine if it contains one or more predefined plurality of keywords. The predefined keywords relate to information relevant to the trading of financial instruments and which can be used or addressed by a market participant in the trading of financial instruments.

If one or more predefined keywords are present in the communication, the communication is converted into a communications that the market participants' systems can understand, interpret and/or be configured to accept. Accordingly, the session manager 3 scans the IM communication and if one or more predefined keywords are present in the communication, the session manager 3 converts it to a communication (or responsively creates a new communication) that is compliant with the communication protocol used by the market participants 9, e.g., a financial information exchange compliant communication. In one embodiment, the IM message is converted to a financial information exchange compliant communication such as a FIX protocol communication, although conversion/formatting, etc. into any appropriate communication may be performed in accordance with the present invention. In addition to handling of such inbound communications (from an IM customer 1 or market participant 9), the system is capable of handling outbound communications (to an IM customer 1 or market participant 9).

The customer 1 can use the client device 20 to communicate or transmit their order entry and market data. In addition, the customer 1 can have access to certain aspects of the facility platform 50 via an HTTPS interface 16 with an administration server website 15 so that the customer 1 can view and execute certain administrative tasks. For example, the customer can cancel their own outstanding orders, view executed order, and clearing status and perform other administrative tasks.

The system identifies a set of exchange-defined spreads, regardless of the order the outrights are input, and disseminating the order via the financial information exchange compliant communication. Any messaging service may be used to deliver the message (e.g., instant messaging, face book, twitter). The system allows users to build spreads (combinations of multiple options contracts which are commonly referred to as the “legs” or “outrights” of the spread), parses the outrights, and analyzes the permutations to create. Most electronic matching engines require that, in order for spreads to be recognized as the same and therefore to be executed against one another, both the individual legs of the spread, and the order in which the legs were entered into the system must be identical. Certain common combinations of outrights will be recognized as “exchange defined spreads,” while variations on those that do not fit the library of common combinations are typically referred to as “user defined spreads.” For example, Customer 1 desires to Buy a Call Vertical, a commonly used “exchange defined spread” in which the Customer buys 1 July 104c and sells 1 July 110c. Customer 2, wishing to sell the Call Vertical to Customer 1, will be selling 1 July 104c, and buying 1 July 110c. In order for Customer 2's order to be identified by as a Call Vertical, and therefore as “executable” against Customer 1's order, Customer 2 must input the legs of the spread in the same order as Customer 1, with the buy leg first. If Customer 2 inputs their spread as selling 1 July 104c and buying 1 July 110c, the order will not be identified as the exchange defined Call Vertical, and will instead be identified as a generic user defined spread. As a result, Customer 2's order will not be executed against Customer 1's order. In order to prevent this, the disclosed invention parses and analyzes permutations of user defined spreads and automatically builds exchange defined spreads from the outrights, regardless of the order in which they were entered, according to a hierarchy. As a result, Customer 2's order would be parsed and interpreted by the system as the exchange defined Call Vertical, and therefore would be “executable” against Customer 1's order. Though this example involved only a two-legged spread, the system is capable of parsing and finding permutations in spreads with a virtually unlimited number of legs.

The system also uses a virtual buddy that appears as an avatar for the user. The virtual buddy is actually a computer or daemon that receives the user input and translates the input into a message format for output to the exchange and/ or other configurable output formats. The virtual buddy may have various social network subscriptions, including a twitter account, face book account, and/or other formats to send market information to friends, colleagues, followers, and subscribers.

Referring back to the session manager 3, as noted before, it is the primary interface for the facility platform 50. In that regard, the session manager 3 controls the message routing, houses the scanner and chat parser, the financial information exchange compliant communication converter library, the instrument manager and the clearing API libraries. The financial information exchange compliant communication converter library provides a means such as a look up table or a translation table where a text based natural language can be converted to symbols, letters, numbers, combinations of each, and/or combinations of one or more symbols, letters, and numbers and vice versa. In this way, a text-based IM message can be converted to an appropriate financial information exchange compliant communication and vice versa.

The session manager 3 also communicates with a facility engine 5 and a facility market data 11 via, for example, a publish-subscribe bus, although other forms of communication may be used. For example, inbound requests and orders from customers 1 are scanned as noted above, parsed at the session manager 3, routed 4 to the facility engine 5, routed 6 to the market data server 11, and routed 8 as an outbound financial information exchange compliant communication message to the market participants 9 as well as routed 2 to customers 1 as a text-based chat message. The routing or communication to the facility engine 5 and to the market participants 9 can occur simultaneously, sequentially, or in some other order.

Similarly, inbound financial information exchange compliant communication messages from market participants 9 are routed 7 to the facility engine 5. Once processed, market data is routed to the facility market data server 11 via 6 and disseminated to market participants 9 via 8. Market Data is also forwarded to the Session Manager 3 via 10 for translation into chat and Graphical User Interface (GUI) updates. Customers 1 receives these market data updates via 2 in the form of text-based chat messages and graphical updates to their client 20. Additionally, the session manager 3 can communicate or route via 12 a financial information exchange compliant communication to a clearing house 13 such as CME's ClearPort. Alternatively, the session manager 3 may route the message via 12 to the clearing house 13 as another proprietary application programming interface (“API”) communication.

Additionally, the session manager 3 is optionally configured to communicate with a compliance system not shown. Such a compliance system records communications including the IM communications from the customer 1 and financial information exchange compliant communication from the market participants 9.

The facility engine 5 includes the order book within the facility platform 50. The order book contains a list of interested buyers and the list of interested sellers of a particular financial instrument. For each entry the order book maintains and identifies, among other things, information to identify the party or parties, the number of amount of the financial instrument to be traded, and the price that the buyer or seller are asking/bidding for the particular financial instrument. Those of skill in the art understand order books, their creation, and the information contained within an order book.

As noted above, appropriate customer 1 messages or communications are translated by the session manager 3 into financial information exchange compliant communication messages which are routed 4 to the facility engine 5 together with the inbound market participant 9 financial information exchange compliant communication messages where the facility engine 5 accumulates and stores the messages. In other words, the customer information and the market participant information is routed to the facility engine 5 where one or more order books are created and/or augmented.

The facility engine 5 may also include matching engine where the interest of buyers and sellers can be satisfied. Matching and resultant execution reports are disseminated from the facility engine 5 via the connection 4 to the session manager 3.

In addition, an administration server 15 is connected 14 to the facility engine 5 so that a view of the order book and activity throughout the system can be monitored by an administrator using for example a computer display (not shown). The administration server 15 also allows customers 1 via a connection 16 to view and cancel their orders and executions in the system as well as perform other administrative tasks. An administrator may add/modify/delete users and accounts, manage firm risk, and view executed trades. They may also view activity throughout the system, including RFQs and subsequent activity, trades, users, chat data, and more. In addition, users and accounts can be added/modified/deleted, product entitlements can be set, and new users can be validated against clearing entities 13.

Additionally, the facility engine 5 may also store all information relating to the customers 1, the market participants 9, their respective communications and communications sent to and from the clearing entities 13 to meet any necessary or desired regulatory requirements.

An external market participant 9 or several external market participants 9 communicate 7, 8 through financial information exchange compliant communications with the session manager 3 and the market data server 11, respectively. The server 3 and the market data server 11 are connected through a publish-subscribe bus 10 or the like. The market data server 11 houses all market data for the platform 50 that results from order entry activity via the facility engine 5. The market data server 11 maintains a connection 6 to the facility engine 5 and a financial information exchange compliant communication connection 8 for market data dissemination to each market maker 9.

Matched orders are sent to an external clearing entity or house 13 via the communication 12 by a financial information exchange compliant communication, proprietary API, or some other means.

It will be appreciated by one of skill in the art that the servers (and/or engines) 3, 5, 11, and 15 may reside in a single unit, in separate units, or in some combination. In addition, each server may be physically located in the same area or may be physically separated.

In addition, while the communications and routing between servers 3, 5, 11, and 15 have been described as TCP connections, it will be appreciated that they can communicate with each other and with one or more client devices 20 via a communications network. By way of example, the communications network could be a local area network (LAN), wide area network (WAN), an intranet, the Internet, etc. Any network configuration allowing data to flow between points of access may be used.

As noted above, inbound IM messages are directed to the session manager 3. The session manager 3 scans the communication to determine if or identify whether it includes or likely includes at least one of a predefined plurality of keywords. In particular, the IM communication is initially sent through a set of validating expressions and any IM communication that fails the initial validation is immediately rejected. A response in the form of an IM communication may be sent to the customer 1. Alternatively, the IM communication can be transmitted to the intended recipient without further action.

For example, the IM communication is scanned to determine if at least one of a predefined plurality of keywords are present. For example, the IM communication is scanned to identifiers commonly used by traders for market actions such as a name or description of financial instrument, a set of months and years, a set of strikes, a strategy type, optional underlying prices and delta strings, or action tokens which define the action to be performed such as, e.g. “buy”, “sell”, “request for quote”, “cancel” or other terms, or synonyms/alternatives thereof (e.g. “b” for “buy”, “s” for “sell”, “rfq” for “request for quote,” etc.). Any suitable scanning technique may be implemented, as will be understood by those skilled in the art.

On the other hand, if the communication does not contain at least one of a predefined plurality of keywords, i.e., “Happy Birthday Frank”, then the session manager 3 may direct the communication to Frank or may simply reject the message and return it to the sender/customer 1.

If the IM communication contains one or more of a predetermined set of keywords, then the communication is parsed to identify the relevant trade parameters of the trading orders. Any suitable parsing technique may be used as will be appreciated by those skilled in the art. In one embodiment, the customer 1 may be permitted to compose free-form, natural language IM communications that include their trading orders. For example, the IM communication may be “request for quote for crude oil June 2011 buy at 8450 and sell at the 8500 and 8550 strike”. Any of various known techniques may be used to examine the content of such a natural language IM communication and extract relevant terms believed to be trade parameters. In this example, the parsing may result in interpretation of the IM communication as a valid request for quote.

More sophisticated customers 1, however, may provide an IM communication that is properly formatted such that the amount of parsing required is negligible. For example, a customer 1 may provide the following IM communication lo z0 75 c, which is interpreted as the financial instrument (crude oil option), the month and year (December 2010 expiration), the strike (75 strike), and the strategy type (call option). The session manager 3 prepares or transforms the IM communication to create a communication that is properly formatted, carries the corresponding trade parameters in the appropriate fields, and is otherwise acceptable as a financial information exchange compliant communication. In those instances, where the financial information exchange compliant communication is a FIX protocol communication or a related FIX protocol communication, a more detailed description of such is provided on the fixprotocol.org website and is incorporated herein by reference. In particular, the session manager 3 hosts software that scans the IM communication, parses it, and converts it to a financial information exchange compliant communication. The financial information exchange compliant communication is then transmitted from the session manager 3 to the market participants 9 and to the facility engine 5. In one embodiment, the financial information exchange compliant communication generated by the server is simultaneously transmitted to the market participants 9 and to the facility engine 5.

It is also contemplated that when the customer 1 provides an IM communication that is properly formatted such that the amount of parsing required is negligible, a “real time” translation feature is provided. The real time translation would convert the properly formatted IM communication into a natural language text based communication that could be viewed and read by the customer 1. For example, if a customer 1 typed the following: “+25v86/88cs”, the communication would be transmitted from the client device 20 to the electronic facility platform 50 where the session manager 3 will utilize a translation table to convert the communication to a natural language text where it will then be sent back to the customer 1. In the example above, where the text is “+25v86/88cs”, the translator would send the customer the following: buy 25 October 86/88 call spread.

Optionally, an authentication step is included in which it is confirmed that the customer 1 has the permission to trade using the electronic facility platform 50. For example, meta-information related to the customer 1 may include identification information relating to the customer 1 and/or other information such as a date and time of the IM communication.

In accordance with the present invention, transactions and other communications from, for example, the market participants 9 are reported to the customer 1 via an IM outbound communication (that is, from the market participant 9 through the facility platform 50 to the client 1) without the need for human intervention.

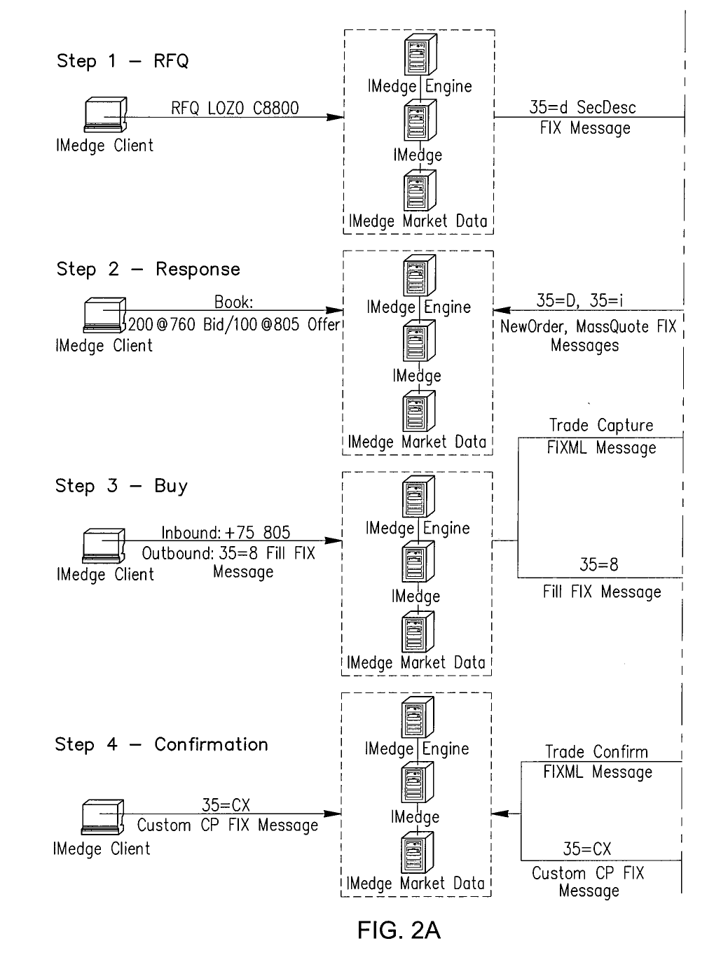

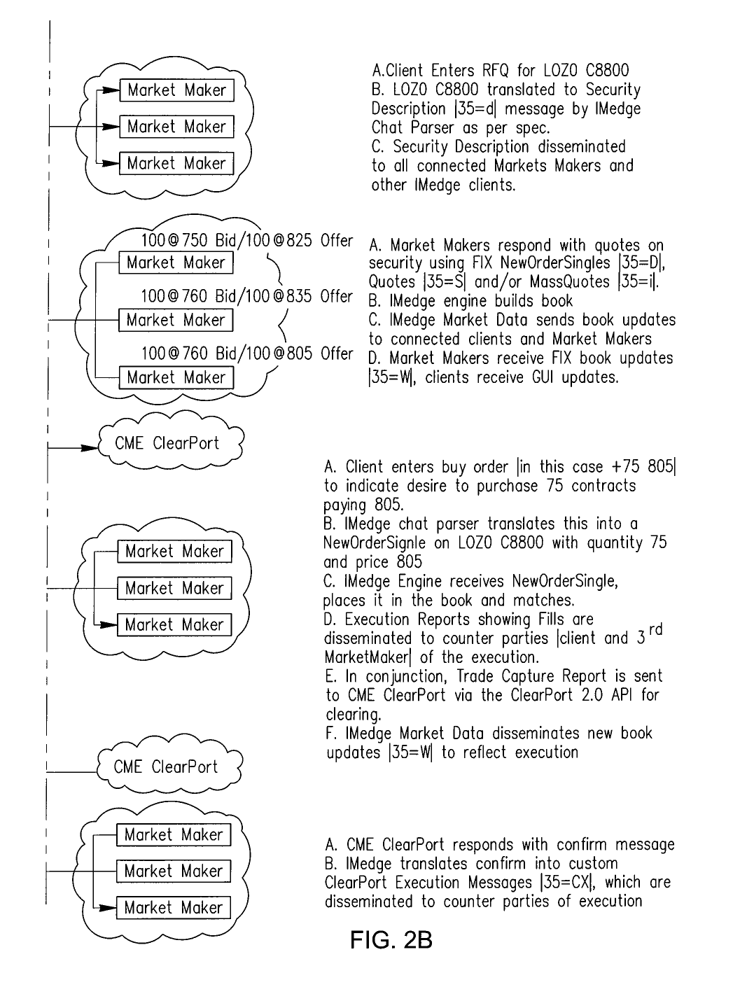

FIG. 2 is a block diagram of an exemplary transaction according to the principles of the present invention and the details of the depicted transaction will be described below.

The session manager 3 includes conventional server hardware storing and executing specially configured computer software for carrying out one embodiment of the method in accordance with the present invention. For example, the session manager 3 may be implemented as a specially configured server, which may optionally include the financial information exchange compliant communication gateway and/or the IM gateway. By way of example, conventional server hardware including a processor containing an operating system such as Red Hat Enterprise Linux or any typical Microsoft Windows server software (Windows 7, etc.) may be used. Such hardware is known to those of skill in the art and the type of hardware is not particularly critical to the practice of the invention. The session manager 3 is configured to communication with an IM network. The session manager 3 may be configured with open source software and/or proprietary software for this purpose. In addition, the session manager 3 includes software that allows communication to a financial information exchange compliant communication network. The session manager 3 may include software written in Java or other programming languages to provide the messaging, storing and processing of the messages between the IM and financial information exchange compliant communication networks.

The session manager 3 includes a general purpose microprocessor (CPU) and a bus employed to connect and enable communication between the microprocessor and the components of the session manager 3 in accordance with known techniques. The session manager 3 typically includes a user interface adapter, which connects the microprocessor via the bus to one or more interface devices, such as a keyboard, mouse, and/or other interface devices, which can be any user interface device, such as a touch sensitive screen, digitized entry pad, etc. The bus also connects a display device, such as an LCD screen or monitor, to the microprocessor via a display adapter. The bus also connects the microprocessor to memory and long-term storage (collectively, “memory”) which can include a hard drive, diskette drive, tape drive, etc.

The session manager 3 may communicate with other computers or networks of computers, for example via a communications channel, network card or modem. The session manager 3 may be associated with such other computers in a local area network (LAN) or a wide area network (WAN), and operates as a server in a client/server arrangement with another computer, etc. Such configurations, as well as the appropriate communications hardware and software, are known in the art. The session manager 3 hardware also may include proprietary software for communicating with the clearing facility 13 such as with CME's ClearPort.

The server's software is specially configured in accordance with the present invention. Accordingly, the session manager 3 may include various software-implemented components, including a communication scanner module for scanning IM communications received from a customer 1 to determine whether such communications likely include one or more of a predetermined set of keywords, an inbound processor module to parse those IM communications that contain the one or more of a predetermined set of keywords. The session manager 3 may also include a composer module for converting the text-based IM message to a financial information exchange compliant communication and transmitting the financial information exchange compliant communication to a market participant 9 and/or to the facility engine 5. The session manager 3 may also include an outbound processor module for parsing a financial information exchange compliant communication and converting the financial information exchange compliant communication to create a text-based IM communication to identify trade details, and an outbound communication module for transmitting the IM communication via a communications network. The outbound communication module may also communicate with a clearing facility. The inbound processor module may communicate directly with the outbound communication module for receiving and sending confirmatory IM communications.

Optionally, the session manager 3 hardware includes software for connecting to the third-party IM networks. Preferably, all IM communications are logged within the facility platform 50 for compliance. The session manager 3 connects an Instant Messaging network to a financial information exchange compliant communication network. It does this by listening for events from either network, and taking appropriate actions when an event occurs. For example, one type of event could be the arrival of an IM communication.

Software programming code for carrying out the inventive method is typically stored in memory. Accordingly, the session manager 3 stores in its memory microprocessor executable orders including programs for carrying out the methods described above.

Additionally, the session manager 3 may include computer readable media storing computer readable code for carrying out the method steps identified above. The computer readable media stores code for carrying out subprocesses for carrying out the method described above.

A computer program product recorded on a computer readable medium for carrying out the method steps identified above. The computer program product comprises computer readable means for carrying out the method described above.

As discussed above, the customer 1 client device 20 may optionally be configured with specially configured IM client software instead of conventional, commercially available IM client software. In addition to permitting a user to send IM communications, such specially configured IM client software may provide the ability to connect to multiple, different IM networks, such as AOL, MSN, GOOGLE, etc. and to display corresponding chat windows for each network within a single client window, such that multiple IM communications sessions may be viewed concurrently within a single client software application. Alternatively, the client device may include known chat aggregators.

Specially configured IM client software may provide for a quick-reply feature, whereby frequently used responses/orders/commands are available for quick selection from a menu. Such specially configured IM client software may be configured to provide a split chat window whereby IM communications between the customer 1 and requests for quote are viewed in a window that is separate from IM communications sent or received in an automated fashion to or from facility platform 50.

Referring now to FIG. 2, one embodiment of the present invention is shown. According to the process, a customer 1 accesses the electronic facility platform 50 through a client device 20 such as a computer, a PDA, a phone, etc., and communicates a market action. In this non-limiting example, the client enters a request for quote (RFQ) for LOZO C8800, which is received by the session manager 3. The session manager 3 scans the IM message and determines that it contains at least one of a plurality of keywords, e.g., “RFQ”. The message is then parsed to identify at least one parameter corresponding to the respective market action and translated it into a financial information exchange compliant communication. The financial information exchange compliant communication is routed to the facility engine 5 to build an order book or to augment an existing order and to at least one market participant 9 and/or other customers 1. With respect to transmitting to other customers 1, the transmission may be sent as an IM message or as a financial information exchange compliant communication depending on the capability of the customer 1 to receive financial information exchange compliant communication.

Upon receiving the RFQ, one or more market participants 9 may respond via financial information exchange compliant communication with quotes, which is received by the session manager 3 and transmitted to the facility engine 5, and more particularly to augment an existing order book. The order book information is transmitted to the market data server 11, where it is disseminated to connected customers 1 and market participants 9. In this regard, the market participants 9 receive the information in a financial information exchange compliant communication format and the customers 1 receive the information as a GUI update or IM message.

The customer 1 upon receiving the order book information can place a market action order such as a buy order, via a client device 20 which is received by the session manager 3, which, if valid, will translate it to a financial information exchange compliant communication and transmit it to the facility engine 5 and to the market participants 9. The facility engine 5 will place the message in the order book and the match engine will determine if there exists a match, and if a match exists, an execution report indicating a filled order is simultaneously disseminated to the market data server 11, the counterparties (the customer 1 and the respective market participant 9), and to a clearing house 13. The execution report is sent to the customer 1 as a GUI update or IM message and to the respective market participant 9 as a financial information exchange compliant communication. In addition, the market data 11 disseminates new order book updates to reflect execution of the order.

With respect to the match engine, it is contemplated that the matching engine will determine if a match exists between one or more of a market action communication, one or more of a financial information exchange compliant communication transmitted and one or more of a market action communication and a financial information exchange compliant communication. Put another way, the matching engine will determine if a match exists regardless of the sender of the communication.

Confirmation of the trade as a financial information exchange compliant communication is received by the electronic facility platform 50 from the clearing house 13 where the session manager 3 translates it to an IM message for transmission to the customer 1. The server 3 can send a confirmation to the respective market participant 9 or the confirmation from the clearing house 13 can be sent directly to the market participant.

While the method of the present invention has been illustrated and described in connection with text-based IM messages, it is contemplated that method could be applied to a Graphical User Interface (GUI) based or icon point and click methods and devices. For example, one or more GUIs could represent parameters of market actions. A point and click device such as a touch screen, a touch pad, a mouse or other known point and click devices could be used to select the one or more desired GUIs or icons and by “clicking” on the desired GUI or icon, information could be transmitted to the session manager 3 where it can be converted to a financial information exchange compliant communication. In this regard, it is contemplated that such “point and click” methods contemplate an action such that when a GUI or icon is selected and clicked, the action is translated into a text-based message, which could be sent as an IM message to the electronic facility platform 50.

It is also contemplated that the methods and systems of the present invention could be applied to operations relating to futures routing such that the customer 1 can transmit messages to communicate a market action in listed futures, listed derivatives, or other similar known markets. It would be understood by one of skill in the art that such IM or other text-based messages would be translated by a suitable translation table to provide a financial information exchange compliant communication suitable for such markets.

The translation table illustrates example translations for the messages, and translations may not be case sensitive.

| | Computer |
|---|---|
| User Input | Translation |
| “f” | January |
| “g” | February |
| “h” | March |
| “j” | April |
| “k” | May |
| “m” | June |
| “n” | July |
| “q” | August |
| “u” | September |
| “v” | October |
| “x” | November |
| “z” | December |
| “X” where X = last 1 digit of year | 201X |
| “XX” where XX = last 2 digits of year | 20XX |
| “MX” where X = last 1 digit of year and | MonthYear (ie. |
| M represents one of the months listed above | N1—July 2011) |
| “buy” | Buy |
| “b” | Buy |
| “+” | Buy |
| “sell” | Sell |
| “s” | Sell |
| “−” | Sell |
| “out” | Cancel |
| “im out” | Cancel |
| “I'm out” | Cancel |
| “out of everything” | Cancel All |
| “cancel all” | Cancel All |
| “rfq” | Request for Quote |
| “quote” | Request for Quote |
| “whats there in the” | Request for Quote |
| “what's there in the” | Request for Quote |
| “?” | Request for Quote |
| “XXXX”—where x is a digit | Depending on position, |
| | recognized as a strike |
| “xDDDD” | Future's price at which |
| | to cover strategy |
| “dXXX” | Hedge quantity for covering |
| | future (can be negative to |
| | indicate sell) |

Below is the set of currently recognized spreads throughout the facility. Combinations of legs that do not fit pre-defined rules fall into a “generic” bucket, but can be traded in the same way as any of these recognized types. Future embodiments of the system will expand this list.

| Recognized Strategy Names | Spread Type |
|---|---|
| “c”, “call” | call |
| “p”, “put” | put |
| “std”, “\hat{ }”, “str”, “straddle” | straddle |
| “stg”, “strangle” | strangle |
| “cv” | call vertical |
| “pv” | put vertical |
| “ch”, “chz” | call horizontal |
| “ph”, “phz” | put horizontal |
| “cd” | call diagonal |
| “pd” | put diagonal |
| “cs” | call spread |
| “ps” | put spread |
| “c1x2”, “c1x3”, “c2x3” | call ratio 1x2, 1x3, 2x3 |
| “p1x2”, “p1x3”, “p2x3” | put ratio 1x2, 1x3, 2x3 |
| “cfly” | call butterfly |
| “pfly” | put butterfly |
| “ccon” | call condor |
| “pcon” | put condor |
| “ctree” | call christmas tree |
| “ptree” | put christmas tree |
| “f”, “fen”, “fence” | fence |
| “ifly” | iron butterfly |
| “stdspd”, “strspd”, “strspr” “stdspr” | straddle spread |

Below is an exemplary table of non-limiting chat translations that may be used by the system to convey market intentions.

Example Chat Parsing

| Inbound Chat Message | Resulting Market Action |
|---|---|
| “rfq lo v1 90 c” | Request for quote on the October 2011 |
| | 9000 Call in Crude Oil (build if necessary) |
| “rfq lo v1 90 \hat{ }” | Request for quote on the October 2011 |
| | 9000 Straddle in Crude Oil (build if |
| | necessary) |
| “rfq lo v1 80/90/100 | Request for quote on the October 2011 |
| cfly” | 8000/9000/10000 Call Butterfly in Crude Oil |
| | (build if necessary) |
| “rfq lo v1 90 c x9025 | Request for quote on the October 2011 |
| −d45” | 9000 Call in Crude Oil, selling 45 October |
| | 2011 futures at 90.25 (build if necessary) |
| “+ 10 100” | Buy 10 paying 100 |
| “− 10 100” | Sell 10 at 100 |
| “out +” | Cancel Bid Order |
| “out −” | Cancel Sell Order |
| “out all” | Cancel all orders |

Any of the logic described above may be implemented in the system as the logic and may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device. The medium may be implemented as any device or tangible component that contains, stores, communicates, propagates, or transports, executable instructions for use by or in connection with an instruction executable system, apparatus, or device. Alternatively or additionally, the logic may be implemented as analog or digital logic using hardware, such as one or more integrated circuits, or one or more processors executing instructions, or in software in an application programming interface (API) or in a Dynamic Link Library (DLL), functions available in a shared memory or defined as local or remote procedure calls, or as a combination of hardware and software.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting.

What is claimed is:

1. A method for communicating a market action to at least one market participant through an electronic facility platform, the method comprising a computerized system:
a. receiving a communication via a communications network;
b. scanning the communication using the computerized system to identify at least one of a predefined plurality of keywords, each of said plurality of keywords corresponding to a respective market action to be addressed by the market participant;
c. if the communication contains at least one of a predefined plurality of keywords, parsing the communication to identify at least one parameter corresponding to the respective market action;
d. converting the communication into a financial information exchange compliant communication selected from one of a FIX protocol, a FIXML protocol, or a FPML protocol compliant communication reflecting the at least one parameter; and
e. transmitting the financial information exchange compliant communication to the at least one market participant via a financial information exchange compliant communication network.

2. The method of claim 1, wherein the communications network includes an instant messaging communications network and the communication includes a text-based instant message (IM) communication.

3. The method of claim 1 wherein the received communication is a communication originates from a point and click method.

4. The method of claim 3 wherein the financial information exchange compliant communication contains at least one of an identification of a financial instrument, a buy or sell instruction, a quantity, and a price, or another market action.

5. The method of claim 4, wherein the financial information exchange compliant communication is simultaneously transmitted to a matching engine to build an order book.

6. The method of claim 5 wherein the system further includes a matching engine that determines if a match exists between one or more of a market action communication, one or more of a financial information exchange compliant communication transmitted and one or more of a market action communication and a financial information exchange compliant communication.

7. The method of claim 2, wherein the parsing is from a textual character string included in a textual body of the communication.

8. The method of claim 1, wherein the receiving of the communication is performed in an automated fashion by the computerized system in response to a human sender operating instant message (IM) client software to provide the market action communication.

9. The method of claim 8, wherein the receiving of the communication is performed in an automated fashion by the computerized system in response to a human sender operating instant message (IM) client software to provide an order to send an IM communication to a virtual buddy appearing in a buddy list, the virtual buddy corresponding to an automated computer process and not to a human recipient having a corresponding IM buddy identity.

10. The method of claim 1, further comprising: storing, in a memory of the computerized system, the plurality of predefined keywords.

11. The method of claim 1, further comprising: transmitting the communication to an intended recipient if the scanning does not identify at least one of the predefined plurality of keywords in the communication.

12. The method of claim 1, wherein the parsing, converting and transmitting is performed only if the scanning identifies at least one of the predefined plurality of keywords in the communication.

13. The method of claim 12, wherein the predefined plurality of keywords persists in the translation table along with a list of market actions associated with the predefined plurality of keywords.

14. The method of claim 13, wherein the predefined plurality of keywords are translated from natural language into market actions, in the form of financial information exchange compliant communications, according to the translation table.

15. The method of claim 14, wherein the market action being deciphered from the translation table is displayed back to the user in real-time in a standardized, cognizable format for displaying a market action.

16. A method for communicating market actions between at least one market participant communicating via a financial information exchange compliant communication and an instant messaging client device, the method comprising a computerized system: receiving, via a communications network, a financial information exchange compliant communication responding to a communication received by the computerized system via an instant message (IM) communication; parsing the financial information exchange compliant communication to identify details relating to the IM communication; preparing an IM communication that includes at least a portion of the details; and transmitting the IM communication via an instant messaging communications network.

17. A computer program product embodied on one or more computer-readable media, the computer program product adapted for communicating market actions to a computerized electronic facility platform and comprising: computer-readable program code configured to carry out the method of claim 1.

18. A system for processing market actions provided in an instant message (IM) communication, the system comprising: a microprocessor; a memory operatively connected to the microprocessor; a network interface device operatively connected to the microprocessor for communicating via a communications network; and orders stored in the memory and executable by the microprocessor to: scan a communication received via a communications network to identify at least one of a predefined plurality of keywords, each of said plurality of keywords corresponding to a market action to be addressed by one or more market participants; parse the communication to identify at least one parameter corresponding to the respective market action; prepare a financial information exchange compliant communication reflecting the respective market action; and transmit the financial information exchange compliant communication to the one or more market makers via a communications network and to transmit the financial information exchange compliant communication to an engine to create or augment an order book.

19. The system of claim 15, further comprising instructions stored in the memory and executable by the microprocessor.

20. The system of claim 16, further comprising instructions stored in the memory and executable by the microprocessor to: add a record to a database of the electronic facility platform, the record comprising the order and the parameter; and perform an action in accordance with the order and the parameter.

21. A system for identifying a set of exchange-defined spreads, regardless of order, and disseminating them via the financial information exchange compliant communication.

22. The system of claim 21 whereby a graphical user interface is presented to customers wherein a plurality of outrights can be selected, submitted, analyzed, and parsed into a series of exchange-defined spreads and/or user-defined spreads.

23. The system of claim 21 whereby a message sent to the server containing a plurality of outright contracts that can be analyzed and parsed into a series of exchange-defined spreads and/or user-defined spreads.
